(19) United States
(12) Patent Application Publication
(10) Pub. No.: US 2007/0272768 A1
(43) Pub. Date: Nov. 29, 2007

(54) Water-Based Airless Adhesive Application Container

(76) Inventors: Donald R. Williams, Plymouth, MA (US); Michael Atwater, Salem, NH (US)

Correspondence Address: WHYTE HIRSCHBOECK DUDEK S.C., 555 E. WELLS ST., SUITE 1900, MILWAUKEE, WI, 53202, US

(21) Appl. No.: 11/737,965

(22) Filed: Apr. 20, 2007

Related U.S. Application Data
(60) Provisional application No. 60/803,300, filed on May 26, 2006.

(51) Int. Cl. B05B 9/04

(52) U.S. Cl. 239/373; 222/105; 222/399; 239/573

(57) ABSTRACT

A system for spraying an aqueous composition, the system comprising: a container having an inner wall and at least one entry port; a valve connected to the entry port, wherein the container and valve are adapted to contain pressurized materials within the container; an inner layer that is resistant to corrosion from contact with water, wherein the inner layer is in contact with, and at least substantially covers, the inner wall; an aqueous composition; and, at least one propellant, wherein the aqueous composition and the propellant are each disposed within the container and are in contact with each other.

### CROSS REFERENCE TO RELATED APPLICATION

This application claims the benefit of U.S. provisional application Ser. No. 60/803,300 filed on May 26, 2006, pending.

### FIELD OF THE INVENTION

This invention relates generally to aerosol adhesives and, more specifically, to systems to store and deliver aqueous adhesive compositions.

### BACKGROUND OF THE INVENTION

Most water-based adhesives are applied using air-assisted equipment. However, air-assisted applicators are limited to locations where compressed air is available. In addition, they are prone to maintenance problems and difficult equipment adjustments.

Airless canister and aerosol systems offer the advantages of portability, ease of cleaning and convenience over more conventional air-assisted spray systems. Solvent-based adhesives comprise the majority of airless systems but these adhesives have a number of undesirable characteristics: they are health hazards, they are flammable, and they release large amounts of harmful volatile organic compounds (VOC's) into the atmosphere.

Environmental considerations are becoming more and more important in shaping the composition of adhesive formulations. Thus, the formulator must be concerned with toxic, flammable, volatile organic compounds (VOC) content (particularly when organic solvents are used instead of aqueous systems) and hazardous air pollutants (HAPS). For example, insurance agencies are increasing fire insurance premiums for manufacturers storing flammable substances. Chlorofluorocarbons have been shown to damage the ozone layer and have been banned by international agreement.

It is therefore advantageous to develop adhesives that are nonflammable, do not constitute a health hazard and whose only volatile ingredient is water. When combined with a nonflammable, VOC-exempt propellant in pressurized canisters, a convenient product with minimal environmental impact is the result.

The majority of the canisters in the United States are fabricated from steel. Moreover, these steel canisters are the only containers approved by the US Department of Transportation (DOT) for shipment of pressurized adhesives. Unfortunately, water-based formulations are not compatible with steel because corrosion renders the canister unfit for reuse and the particles of oxidized iron quickly clog the spray hoses and guns used for delivery of the adhesive. The presence of iron can also coagulate water-based latexes, leading to line obstruction and malfunction of needle valve assemblies.

The patent literature teaches that anti-corrosive agents can be used in the adhesive formulation to reduce the adverse effects of rust. The U.S. Pat. No. 5,931,354 (Brand et al.) discloses the use of corrosion inhibitor Cortec M-435 in a water-based, pressurized canister. Corrosion inhibitors are not always effective for long periods of time, however, which prevents environmentally advantageous reuse of the metal canister. Moreover, the adhesive properties can be adversely affected by the presence of these corrosion inhibitors.

Other uses of water-based products in aerosol cans have been described in a number of patents. Alcohol additives and polymer mixtures are used in U.S. Pat. Nos. 4,420,575 (Rapaport et al.) and 4,265,797 (Suk) to improve sprayable paint systems. The latter patent cites use of a high pH to control corrosion. Horwat et al. (U.S. Pat. No. 4,004,049) improve latex spray adhesion by introducing a controlled instability. However, this technology has only occasionally been mentioned for an adhesive in a package larger than one liter.

In one such patent (U.S. Pat. No. 5,444,112), Carnahan describes neoprene latex adhesives in a canister system but stipulates that large valve and hose sizes (⅛ to ¼ inch) are preferable to prevent “coagulation and clogging of orifices, to which adhesives are inherently susceptible.” The canisters referenced therein are disposable. Patent examples are limited to formulations for aerosol cans.

An elegant solution to the coagulation and corrosion problems associated with metal canisters has been offered by Hammarth et al. (U.S. Pat. Nos. 6,848,599 and 6,905,084). The use of a collapsible bag (to contain the adhesive) in a canister prevents contact of the water-based adhesive with both the metal canister and with the potentially non-compatible propellant system, which is present in the space between the bag and the canister. These patents also describe a gun that enables the end user to clear the tip when the valve is closed.

While the above inventions have improved prospects for wider use of airless water-based adhesive canisters, there is still more room for improvement. The valve requires two filling ports and is more expensive than conventional valves. Steel cylinders are heavy and ergonomics would dictate a weight reduction. Metal canisters are opaque and there is no efficient way of knowing when the canister is about to run out of adhesive. Leaking bags lead to customer complaints and the resultant rust necessitates disposing of the “reusable” canister.

The focus of the present invention is to remedy the shortcomings detailed above.

### SUMMARY OF THE INVENTION

A system for spraying an aqueous composition, the system comprising: a container having an inner wall and at least one entry port; a valve connected to the entry port, wherein the container and valve are adapted to contain pressurized materials within the container; an inner layer that is resistant to corrosion from contact with water, wherein the inner layer is in contact with, and at least substantially covers, the inner wall; an aqueous composition; and, at least one propellant, wherein the aqueous composition and the propellant are each disposed within the container and are in contact with each other.

An aerosol adhesive system comprising a system for spraying an aqueous composition, the system comprising: a container having an inner wall and at least one entry port; a valve connected to the entry port, wherein the container and valve are adapted to contain pressurized materials within the container; an inner layer that is resistant to corrosion from contact with water, wherein the inner layer is in contact with, and at least substantially covers, the inner wall; an aqueous composition; and, at least one propellant, wherein the aqueous composition and the propellant are each disposed within the container and are in contact with each other.

### BRIEF DESCRIPTION OF THE DRAWING

FIG. 1 shows a schematic of a partial cross-sectional view of a system of the invention.

### DETAILED DESCRIPTION OF THE INVENTION

The following description discusses use of the container for aqueous systems due to the advantages of the inventory for aqueous compositions. However, the container is equally usable for organic solvent-based compositions and such usage is an embodiment of this invention.

End users have benefited greatly from the advent of airless canisters and aerosol cans as formulation delivery systems. Unlike pressure pot systems, the canisters do not have to be cleaned after each use; the canister can simply be shut off for reuse at any time without cleaning. Likewise, there is no need for an air compressor. The inconvenience of extra hoses and the need for a power source are eliminated. Moreover, airless canisters are portable and can be used in remote locations, are compact and can be used in confined spaces and are lightweight and can be easily carried up and down ladders. From small aerosol cans to jumbo canisters for big jobs, airless systems provide convenience, portability and ease of operation that can save money by significantly cutting setup, application and cleanup time.

At the same time, governmental, shipping and environmental regulations have limited the growth of airless systems. It is more difficult to aerosolize airless systems than pressure pot systems simply because not as much pressure is available to the former. The Department of Transportation (DOT) sets a maximum allowable canister shipment pressure at 260 psi at 130° F. Higher pressures, if delivered to the spray gun tip, could better aerosolize the formulation. Insurance companies are becoming less willing to underwrite policies covering manufacturers who use and store flammables and are even less willing to do so if the flammables are under pressure.

Air Quality Management Districts (AQMD) that regulate allowable VOC limits for product lines are very popular in California and the concept is certain to spread to other states. For example, the AQMD regulations prohibit sale of adhesives within the district that have VOC levels above those set by the district. Such regulations apply to both solvents and propellants. Exempt solvents important for the adhesives industry are limited to methylene chloride, acetone, t-butyl acetate and methyl acetate. Furthermore, California has outlawed methylene chloride, one of the workhorse solvents for the nonflammable adhesives market. The only widely available, reasonably priced exempt propellants are Dymel® 134A and Dymel® 152A. The adhesives canister industry finds itself in a very small box if it is to conform to DOT regulations for pressure, provide a nonflammable product and limit VOC content. Moreover, airless systems will not provide a good spray pattern if the propellant system is not compatible with the adhesive formulation.

The logical solution to the dilemma is to develop more water-based airless adhesive systems. There are two major drawbacks to water-based adhesives.

The first is that water-based systems do not dry as fast as the corresponding solvent-based adhesive formulations. This is problematic for the end user since it increases production time and decreases production efficiency. Two of the better approaches to reducing drying time depend heavily on the availability of reliable, convenient delivery systems for the water-based adhesives. High solids, water-based systems are generally available up to 72% solids. Evaporation time decreases as the percent of solvent increases. Engineering options for the spray nozzle can increase the droplet surface area, further increasing the evaporation rate. Sprayed (and especially airless sprayed) high solids, water-based systems are the way to go to decrease drying time and increase unit output.

Second, water causes corrosion of the predominant canister material, carbon steel. Not only do the particles of iron oxide have the potential to jam the canister guns and hoses but iron will also coagulate many water-based adhesives preventing smooth, reliable canister operation in the end user's hands. Corrosion also makes it difficult, if not impossible, to reuse the metal canister.

The teachings of the Hammarth et al. patents (U.S. Pat. Nos. 6,848,599 and 6,905,084) provide valuable improvements to the airless canister technology for water-based adhesives: 1) the corrosion problem has been solved; 2) propellant and adhesive formulation have been physically separated so that incompatibility issues are no longer important; and 3) a cleaning technique for the spray tip has been found.

The bag-in-canister concept requires use of a valve with two filling pathways, one for transporting the adhesive into the bag and the second for pressurizing the propellant in the space between the bag and the canister. Such valves are invariably more expensive and the added complexity provides more possible failure modes. Although the metal canister is no longer subject to corrosion, it remains heavy and opaque, defying effortless portability and resistant to efforts to know the level of the remaining adhesive.

Much of the success of the bag-in-canister system relies on the durability of the bag. If the bag breaks: 1) the end user can no longer spray the adhesive; and 2) the interior of the canister corrodes and cannot be reused. Moreover, it is not a trivial operation to secure the bag to the valve, insert the valve/bag assembly into the canister and thread the valve into the canister without tearing the bag. Similarly, removing the used bag, cleaning the inside of the canister and replacing the bag results in an added cost and operational level of complexity.

One possible solution to the corrosion problem involves use of non-corrosive metals. Aluminum is lightweight and reasonably priced but still rapidly forms an oxide layer on the surface. Metals such as stainless steel and nickel strongly resist corrosion but are prohibitively expensive for this application. Other metals are unsuitable due to toxicity. Some metals that do not corrode are still likely to coagulate water-based adhesive formulations.

Another approach has been to add anti-corrosive agents to the formulation. Helmitin Inc. practices this technology as reported in the Helmiprene 1776 technical product bulletins. Not only do anti-corrosive agents add cost, but they have often been found to interact unfavorably with the adhesive, causing substantial reduction in adhesive strength, solvent resistance, water resistance, use temperature and the like. Those who are skilled in the art know that selection of the optimum anti-corrosive agent and the proper level for a water-based adhesive is time-consuming and results are not always ideal. While anti-corrosive agents can be found that will substantially retard corrosion, it is more likely that enough corrosion will still be present to prevent reuse of the canister.

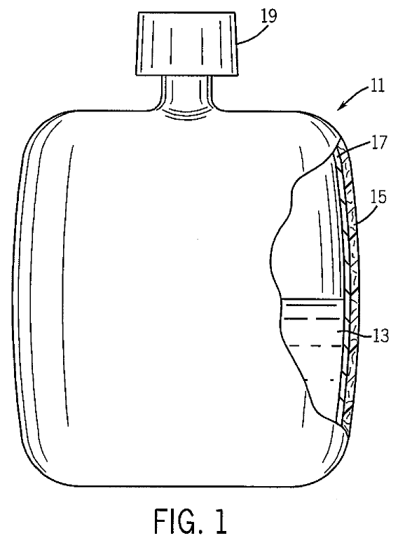

As shown in FIG. 1, a preferred embodiment of the invention comprises a canister 11 containing a pressurized aqueous composition 13. Canister 11 comprises a shell 15 that provides structural strength to canister 11 and serves in part to protect the contents of the canister. An internal layer 17 is interposed between the inner wall of shell 15 and the aqueous composition 13.

Shell 15 can be made from any material having sufficient strength to safely contain the pressurized composition 13 and also having sufficient impact resistance to prevent the canister from breaking or denting during normal use. Typically, shell 15 will be made from a metal or a composite. Normally the metal will be carbon steel, although other metals such as stainless steel, aluminum, nickel, brass or bronze alloys, etc. could be used if desired or warranted by the end use application.

Composites usable for the shell 15 include fiber reinforced polymers. Such composites are well-known in the art and generally consist of a cured polyester resin imbedded with glass fibers. Composite canisters will typically have an outer layer to provide at least one of the following desirable characteristics: resistance to damage from the environment; improved appearance; and/or impact resistance. Such canisters are not yet DOT-approved in the United States but are used extensively in Europe to transport pressurized, flammable liquid petroleum gas (LPG). The composite canisters 11 are light-weight, easy to clean and have visible liquid level.

Internal layer 17 may be either a lining or a coating. Internal layer 17 may comprise any material that is substantially inert to both the aqueous composition 13 and the material of shell 15 and is substantially impermeable to water under pressure. Substantially inert to the aqueous solution means that the internal layer material neither corrodes or disintegrates in the presence of the composition 13 nor causes sedimentation or coagulation in composition 13. Substantially inert to the shell material means that neither the layer material nor the shell material chemically or galvanically corrode the other.

Typically, internal layer 17 may be a thermoplastic polymer, a rubber or elastomeric polymer, an enamel, an epoxy, a glass, or a cladding. Examples of polymers that are suitable for this application include, but are not limited to, polyethylene, polypropylene, EPDM, butyl rubber and polyester. The polymers may be formed or molded into a liner that has enough rigidity to maintain its shape. The liner can be inserted into the canister while the canister is being manufactured. Liners will normally be formed to fit against the inside surface of shell 15. Alternatively the material of inner layer 17 may be applied to the inner surface of shell 15 to form a coating.

Standard valves 19 can be used for filling since the propellant and the canister are loaded into the same space. There are currently several composite canister suppliers.

The second preferred embodiment of the current invention involves use of composite canisters as containers for the adhesive. Composite canisters are used extensively in other parts of the world to transport pressurized materials. LPG is both volatile and flammable but in Europe, it is increasingly transported in composite canisters. In a fire, metal canisters containing LPG detonate explosively, spreading the fire to more distant locations. The composite canisters, on the other hand, melt and split, limiting the spread of the burning contents. Insurance carriers seeking to limit their losses are encouraging the used of composite canisters for storing flammable materials. Typically, composites are multi-layered with the inner layer providing resistance to permeability, a middle layer (usually of fiberglass-reinforced resin) lending strength and rigidity and an outer layer protecting against impact. A preferred embodiment of the inner layer is polyethylene although, in theory, any moldable, non-permeable material that can withstand pressure is suitable. A broader list includes, but is not limited to polypropylene, EPDM, butyl rubber and polyester. Composite canisters are not yet popular in the United States but are currently being evaluated by the appropriate government agencies. Once approvals have been secured, their use will surely increase.

Both of the preferred embodiments of the invention allow use of a standard filling valve, are reusable and avoid the complexity and potential lack of robustness of the bag. Both are also complementary to the bag-in-canister concept in that they can be used for adhesive formulations where the adhesive and the propellant can coexist. Where they cannot coexist, the bag-in-canister, although more complex, is a viable option. In addition, the filled composite canister is only two-thirds of the weight of a comparably sized filled metal canister and is transparent enough to allow the end user to monitor the adhesive level.

In one preferred embodiment, the aqueous composition of this invention is an aerosol adhesive. As is well-known in the art, such adhesives are composed of active ingredients (e.g. rubbers, resins, and additives), solvents, and propellants. In this invention, the adhesive solvent will be predominantly or exclusively water. Less preferably, from a VOC standpoint, the solvent could include VOC solvents such as aliphatic compounds such as pentane, hexane, cyclohexane, heptane, and aromatic compounds such as toluene and xylene. VOC exempt solvents could also be included as a component in the aqueous composition, including, for example, acetone, methylene chloride, perchloroethylene or trichloroethylene. The solvent content of aerosol adhesives range between 18 to 79 percent and average about 39 percent. For water-based adhesives, higher solids content (i.e., lower solvent percentages) provide shorter drying times.

Propellants usable in the invention are known in the art. Typical VOC propellants are propane, butane, isobutane, and dimethyl ether. The propellants HFC-134a and HFC-152a are non-VOC propellants that can be used in spray adhesives. Compressed gasses, normally inert gasses such as carbon dioxide or nitrogen, can also be used in spray adhesives. Propellant contents in aerosol adhesives range from 15 to 68 percent and average about 36 percent.

At best, this invention encourages use of nonflammable, non-toxic, low VOC water-based formulations. High water-based solids reduce waste and save time by reducing the number of application passes and the drying time. Both embodiments are reusable and the composite canister adds ergonomics to portability. The convenience and ease of cleaning of airless canisters are also important advantages.

Other benefits of the invention are the lower shipping costs and improved handling due to the lower canister weight. Also, the composite canister can be translucent, allowing a user to see the level of the liquid in the canister.

The scope of the invention is not limited to water-based adhesive applications in airless spray systems. Other possible applications consist of water-based food products, lubricants, insecticides, herbicides, cosmetics, paints, coatings, inks, cleaning agents, foamed insulation, rust removers, personal care products and the like. Also, solvent-based compositions are within the scope of this invention.

The details and importance of the described invention will be made clear by the following non-limited examples. The adhesive formulation used in the examples consists of a generic water-based resin-modified neoprene adhesive at 55 to 60 percent solids.

### EXAMPLE 1—UNPROTECTED CANISTER

The generic neoprene adhesive (6.9 pound) was added to a 15-pound metal canister and pressurized with 0.16 pound of nitrogen. The adhesive formulation was allowed to sit for two weeks, at the end of which time it would no longer spray. The canister was cut open and corrosion was observed as well as coagulated latex emulsion at the bottom and inside the dip tube. This shelf stability would be unacceptable to the end user.

### EXAMPLE 2—ANTI-CORROSIVE AGENTS, METAL COUPON TESTS

Anti-corrosive agents were screened by successively adding the generic neoprene adhesive and several levels of various anti-corrosive agents into a 1-pint jar with a 1“×4” carbon steel coupon. Corrosion of the coupon and stability of the adhesive were noted. Table I gives the results of the screening tests.

TABLE I
ANTI-CORROSIVE AGENT SCREEN

| | Anti- | | | | |
|---|---|---|---|---|---|
| EXAM- | corrosive | | | Coupon | Adhesive |
| PLE | Agent | Level | Time | Corrosion | Stability |
| 2A | Butrol 35 | 0.5% | 20 days/50° C. | 5% spot | Sediment |
| 2B | Cortec | 0.5% | 44 days/50° C. | Vapor phase | Sediment |
| | M-435 | | | corrosion; | |
| | | | | decreasing | |
| | | | | spot size, | |
| | | | | <2% area | |
| 2C | | 1.0% | 44 days/50° C. | Vapor phase | Very slight |
| | | | | corrosion; | sediment |
| | | | | decreasing | |
| | | | | spot size, | |
| | | | | <2% area | |
| 2D | | 3.0% | 44 days/50° C. | Vapor phase | No |
| | | | | corrosion; | sediment |
| | | | | decreasing | |
| | | | | spot size, | |
| | | | | <2% area | |

### EXAMPLE 3—ANTI-CORROSIVE AGENT CONTRIBUTION TO SHELF LIFE

Into each of three 15-pound canisters are added successively 3000 grams of the generic neoprene adhesive formulation described above, X grams of anti-corrosive agent and approximately 84 grams of nitrogen. The three canisters were allowed to sit for five months, then cut open and examined for corrosion. Table II summarizes the results.

TABLE II
ANTI-CORROSIVE AGENT CONTRIBUTION TO SHELF LIFE

| | | Anti-corrosive | Stable | Stable to |
|---|---|---|---|---|
| EXAMPLE | X, grams | Agent | to Spray? | Corrosion? |
| 3A | 61.2 | Cortec M-435 | Yes | Splotchy rust - |
| | | | | moderate to |
| | | | | heavy |
| 3B | 92.8 | Cortec M-435 | Yes | Splotchy rust - |
| | | | | moderate |
| 3C | 125.0 | Cortec M-435 | Yes | Splotchy rust - |
| | | | | light |

### EXAMPLE 4—BUTYL RUBBER COMPATIBILITY TESTING

Into each of two I-pint jars are added successively 300 grams of the generic neoprene adhesive and three pieces of cut butyl rubber weighing approximately 8 grams apiece. The lid was screwed on and the jars were allowed to sit at room temperature and at 50° C. for 60 days. At the end of 60 days, the rubber and the adhesive formulation were examined. There was no visible change in or loss of strength to the butyl rubber specimens. The adhesive formulation remained stable in both jars.

### EXAMPLE 5—COMPOSITE CANISTER

Into a 10-kilogram composite canister are added successively 14,074 grams of the generic neoprene adhesive formulation described above and 241 grams of nitrogen. The canister was sprayed every so often for nine months. The adhesive lost none of its properties and continued to spray until emptied at nine months.

What is claimed is:

1. A system for spraying an aqueous composition, the system comprising:
a container having an inner wall and at least one entry port;
a valve connected to the entry port, wherein the container and valve are adapted to contain pressurized materials within the container;
an inner layer that is resistant to corrosion from contact with water, wherein the inner layer is in contact with, and at least substantially covers, the inner wall;
an aqueous composition; and
at least one propellant, wherein the aqueous composition and the propellant are each disposed within the container and are in contact with each other.

2. The system of claim 1, wherein the inner layer is substantially impermeable to pressurized water.

3. The system of claim 1, wherein the inner layer comprises a thermoplastic polymer, a rubber or elastomeric polymer, an enamel, an epoxy, a glass, or a cladding.

4. The system of claim 1, wherein the inner layer comprises a polymer selected from the group consisting of polyethylene, polypropylene, EPDM, butyl rubber, polyester, and mixtures thereof.

5. The system of claim 4, wherein the inner layer comprises polyethylene.

6. The system of claim 4, wherein the inner layer comprises a butyl rubber.

7. The system of claim 1, wherein the container comprises a material comprising a metal or a composite.

8. The system of claim 7, wherein the material comprises a metal, and the metal comprises at least one of carbon steel, stainless steel, aluminum, nickel, brass or bronze.

9. The system of claim 7, wherein the material comprises a composite comprising a cured polyester resin imbedded with glass fibers.

10. The system of claim 1, wherein the inner layer is substantially inert to the aqueous composition.

11. The system of claim 1, wherein the aqueous composition comprises at least one of an adhesive, a water-based food products, a lubricant, an insecticide, an herbicide, a cosmetic, a paint, a coating, an ink, a cleaning agent, a foamed insulation, a rust remover, or a personal care product.

12. The system of claim 11, wherein the aqueous solution comprises an adhesive.

13. An aerosol adhesive system comprising:
a container having an inner wall and at least one entry port;
a valve connected to the entry port, wherein the container and valve are adapted to contain pressurized materials within the container;
an inner layer that is resistant to corrosion from contact with water, wherein the inner layer is in contact with, and at least substantially covers, the inner wall;
an aqueous composition; and
at least one propellant, wherein the aqueous composition and the propellant are each disposed within the container and are in contact with each other.

14. An aerosol adhesive system comprising:
a container for storing and dispensing/spraying aerosolized adhesive from an aqueous composition using a propellant, wherein the container comprises an inner wall having an inner layer and one entry port; and
a valve connected to the entry port, wherein the inner layer is resistant to corrosion from contact with the aqueous composition.

15. A system for spraying a composition, the system comprising:
a container having an inner wall and at least one entry port;
a valve connected to the entry port, wherein the container and valve are adapted to contain pressurized materials within the container;
an inner layer that is resistant to corrosion from contact with water, wherein the inner layer is in contact with, and at least substantially covers, the inner wall;
a composition; and
at least one propellant, wherein the composition and the propellant are each disposed within the container and are in contact with each other.

16. An aerosol adhesive system comprising:
a container having an inner wall and at least one entry port;
a valve connected to the entry port, wherein the container and valve are adapted to contain pressurized materials within the container;
an inner layer that is resistant to corrosion from contact with water, wherein the inner layer is in contact with, and at least substantially covers, the inner wall;
a composition; and
at least one propellant, wherein the composition and the propellant are each disposed within the container and are in contact with each other.

17. An aerosol adhesive system comprising:
a container for storing and dispensing/spraying aerosolized adhesive from a composition using a propellant, wherein the container comprises an inner wall having an inner layer and one entry port; and
a valve connected to the entry port, wherein the inner layer is resistant to corrosion from contact with the composition.

18. A container for storing a preselected non-solvent aqueous composition and a preselected propellant under pressure, said container comprising:
an inner wall having an inner layer that is substantially resistant to corrosion by said aqueous composition and said propellant;
an entry port disposed on said inner wall; and
a valve associated with said entry port, said valve having a closed state where it contains said aqueous composition and propellant within said container and an open state wherein it releases under said pressure at least some of said aqueous composition in the form of a non-solvent based aerosolized adhesive.

19. The container of claim 18 wherein said inner layer is substantially impermeable to pressurized water.

20. The container of claim 18 wherein said inner layer is substantially inert to said aqueous composition.

21. The container of claim 18 wherein said inner layer comprises a material selected from the group consisting of a thermoplastic polymer, a rubber polymer, an elastomeric polymer, an enamel, an epoxy, a glass, and a cladding.

22. The container of claim 18 wherein said inner layer comprises a polymer selected from the group consisting of polyethylene, polypropylene, EPDM, butyl rubber, polyester, and mixtures thereof.

23. The container of claim 18 wherein said inner layer comprises a material selected from the group consisting of a metal and a composite.

24. The container of claim 18 further comprising spraying apparatus operatively associated with said valve.

25. The container of claim 24 further comprising an actuator for toggling said valve between said open state and said closed state.

26. Means for storing under pressure a preselected non-solvent aqueous composition and a preselected propellant and for selectively releasing under said pressure at least some of said aqueous composition in the form of a non-solvent based aerosolized adhesive, said means comprising:
means for containing under pressure said preselected non-solvent aqueous composition and said preselected propellant, said means for containing being substantially resistant to corrosion by said aqueous composition and said propellant;
means for entering said means for containing, whereby said preselected non-solvent aqueous composition and said preselected propellant may be deposited into said means for containing through said means for entering; and
means for selectively constraining and releasing said aqueous composition and propellant within and from said means for containing.
